(19) United States
(12) Patent Application Publication
(10) Pub. No.: US 2014/0177385 A1
(43) Pub. Date: Jun. 26, 2014

(54) METHOD AND DEVICE TO DEGHOST SEISMIC DATA

(71) Applicant: CGG SERVICES SA, Massy Cedex (FR)

(72) Inventor: Ronan SABLON, Massy (FR)

(73) Assignee: CGG SERVICES SA, Massy Cedex (FR)

(21) Appl. No.: 14/078,940

(22) Filed: Nov. 13, 2013

(30) Foreign Application Priority Data
Dec. 26, 2012 (FR) 1262777

(51) Int. Cl. G01V 1/36; G01V 1/34; G01V 1/30

(52) U.S. Cl. CPC G01V 1/36; G01V 1/303; G01V 1/34; G01V 1/38
USPC 367/7; 367/24

(57) ABSTRACT

A method for processing seismic data related to a structure under a body of water to generate an image of the structure includes receiving seismic data acquired using detectors disposed on a depth-varying profile streamer. The method further includes generating, from the seismic data, first traces that correspond to traces as recorded by the detectors and migrated to water surface, and second traces that correspond to traces as would be recorded by virtual detectors mirroring the detectors relative to the water surface and migrated to water surface. The method also includes generating third traces as a sum of corresponding ones among the first traces and second traces, and fourth traces as a difference of the corresponding ones of the first and second traces. The method then includes deghosting at least one of the first and second traces using positive and negative polarity portions of the third and fourth traces.

### BACKGROUND

1. Technical Field

Embodiments of the subject matter disclosed herein generally relate to methods and systems configured to process marine seismic data, including a fast deghosting of variable-depth streamer data.

2. Discussion of the Background

Since the 1980s, reflection seismology has become more and more important in oil and gas industry for mapping and interpreting underground or under sea-bottom geophysical structure, to identify potential oil and/or gas reservoirs.

Marine seismic surveys for acquiring reflection seismic data are conducted using specially-equipped vessels that tow (A) seismic sources such as air-gun arrays that generate waves directed to the subsurface, and (B) cables (named streamers) containing detectors such as hydrophones and geophones that detect reflected waves. The reflected waves are due to the source-generated waves being reflected from seismic interfaces (i.e., where there is a lithological variation or change).

The seismic data gathered during a marine seismic survey may be affected by several natural phenomena. One of these phenomena is water surface noise due, for example, to surface waves. In order avoid water surface noise, detectors are towed below the water surface. However, towing the detectors below the water surface introduces ghosts. In contrast to the direct reflection or primary signal reflected upward by a seismic interface, a ghost is a wave reflection that propagates to the water surface, being reflected downward to the detector by the water-to-air interface (the ghost arriving to the detector slightly later than the direct reflection or primary signal). The primary signals and the ghosts overlap, causing the detector to receive distorted waves (i.e., having a different spectrum) compared to the spectra of waves generated by the source.

Removing the ghosts from traces (e.g., amplitude versus time recorded by the detectors) extracted from the seismic data is more precise if the detectors are placed on depth-varying streamers. For example, in FIG. 1, a marine seismic vessel 10 moving on the surface 12 of a body of water, tows a source 14 and a streamer 16, along which are located a plurality of detectors, 18a, 18b, . . . , 18x. In FIG. 1, the streamer 16 is slanted from its front end to its tail end at a constant slope angle, but having a constant slope angle is merely an illustration and should not be considered a limitation. More generally, the streamer 16 has a depth-varying profile.

Reflection and/or refraction of the wave generated by the source occur at an interface between layers in which the wave propagates with different speeds. A primary signal 20 may be detected by first detector 18a after being reflected at the interface 24 between water and a first rock layer 23. A ghost 22 also reflected at the interface 24 may also be detected by the detector 18a after being reflected a second time on its propagation path at the water surface 12.

In FIG. 1, the speed of the wave propagating through the water (next to the ocean bottom) v₁ is smaller than the speed v₂ of the wave propagating through layer 23, which may be smaller than the speed v₃ of the wave propagating through layer 25, which is then smaller than the speed v₄ of the wave propagating through layer 27 (v₁<v₂<v₃<v₄). These magnitude relationships are exemplary and not intended to be limiting. In this case, when crossing through interfaces 24, 26 and 28, the wave propagation direction changes, making an increasingly larger angle with gravitation direction. Although not shown in FIG. 1, a part of a wave arriving at the interfaces 24, 26, and 28 is reflected and the rest part which is shown in FIG. 1 is transmitted (refracted) in the next layer. Conversely, when crossing the interfaces 28, 26 and 24 while propagating upwards, the wave propagation direction makes a decreasing angle with the gravitation direction.

Another primary signal 32 reflected at interface 30 is detected by detector 18x. A ghost 34, which is also reflected at interface 30, is detected by detector 18x after being reflected at the water surface 12, which acts as a mirror for the waves, with water reflectivity being close to one. Therefore, the ghosts 22 and 34 have reverse polarity in addition to a time lag (due to the longer path) compared to the primary signals 20 and 32. The time lag (delay) depends on the depth of the detector; the larger the depth, the longer the delay between the signal and the ghost. The operation of removing the ghosts from the traces (i.e., amplitude versus time as recorded by a detector) is called deghosting.

A joint deconvolution algorithm described, for example, in U.S. Patent Application Publication Nos. 2011/0305109 and 2012/0092956 by R. Soubaras (both references being incorporated herewith by reference) has recently been used to process variable-depth streamer data.

The receiver/detector depth increasing with the distance from the vessel allows a wide diversity of ghost delays and frequencies, yielding a substantial increase of the possible frequency bandwidth, in both low and high-frequencies sides, from 2.5 Hz to source notch. The joint deconvolution algorithm operates to remove the ghosts by combining a normal image and a mirror image, the images being obtained using wave traces either pre-stack or post-stack. These normal and mirror traces may be obtained either with Normal Move Out (NMO) correction (that aligns in time these traces) or with time/depth migrations.

However, the current pre-stack deghosting methods based on the joint deconvolution algorithm have some disadvantages. First, the time for obtaining intermediate results may be long. Second, the methods require accurate knowledge of the velocity field. Additionally, the methods require an appropriate muting (i.e., removal of a portion of detected signal around notches). The joint deconvolution algorithm yields a better result if migrated data is used, but migrating the data is another time-consuming intermediate step.

In order to improve the effectiveness of processing variable-depth streamer data, other methods for a faster pre-stack deghosting operating in shotpoint domain (with channels regularly sampled) have been considered. However, these methods can be applied only before migration, and, although faster than the joint deconvolution algorithm, these methods have an implicit limitation for some processing stages, such as, velocity analysis or intermediate QC stacks. In these conventional methods, the whole dataset has to be deghosted simultaneously, which is a major drawback when there is a large amount of data.

Accordingly, it would be desirable to provide systems and methods that avoid the afore-described problems and drawbacks.

### SUMMARY

Seismic trace deghosting according to some embodiments described hereinafter is based on wavelet coherency and polarity change between the normal and mirror gathers on each particular trace. Since a primary signal and its corresponding ghost are an image of the reflected wave (approximately before migration, more precisely after migration), with the signal and the ghost having opposite polarities and slightly different amplitudes (due to the water surface reflectivity being less than one, ˜0,9), their role could be reversed. The primary signals are coherent in both the normal and the mirror traces (i.e., the signal polarity is identical on the normal and mirror traces). All other signals are the ghosts. The normal and mirror traces could then be either added or subtracted to generate (A) a “symmetrised” trace in which the primary signals are surrounded by two ghosts, before and after, and (B) a “double ghost” (or “ghost only”) trace, with the pairs of ghosts having different polarity. The better known the velocities, the better is the focus achieved between the signal in the normal trace and its corresponding ghost in the mirror trace. In order to account for water surface reflectivity being different from one, an amplitude correction may be applied to one of the normal traces and the mirror trace to achieve better signal estimation on the “symmetrised” trace and to avoid any residual signals on the “double ghost” trace.

According to one exemplary embodiment, there is a method for processing seismic data related to a structure under a body of water to generate an image of the structure. The method includes receiving seismic data acquired with detectors disposed on a depth-varying profile streamer. The method further includes generating, from the seismic data, first traces (UP) that correspond to traces as recorded by the detectors and migrated to water surface, and second traces (DW) that correspond to traces as would be recorded by virtual detectors mirroring the detectors relative to the water surface and migrated to water surface. The method also includes generating (A) third traces (SYM) as a sum of corresponding ones among the first traces and second traces, and (B) fourth traces (DBG) as a difference of the corresponding ones of the first and second traces. The method then includes deghosting at least one of the first and second traces using positive and negative polarity portions of the third and fourth traces.

According to another exemplary embodiment, an apparatus for processing seismic data related to a subsurface of a body of water to generate an image of the subsurface has an interface configured to receive seismic data acquired using detectors disposed on a depth-varying profile and a data processing unit. The data processing unit is configured to generate, from the seismic data, first traces (UP) that correspond to traces as recorded by the detectors and migrated to water surface, and second traces (DW) that correspond to traces as would be recorded by virtual detectors mirroring the detectors relative to the water surface and migrated to water surface. The data processing unit is also configured to generate (A) third traces (SYM) as a sum of corresponding ones among the first and second traces, and (B) fourth traces (DBG) as a difference of the corresponding one of the first and second traces. The data processing unit is further configured to deghost at least one of the first and second traces using positive and negative polarity portions of the third and fourth traces.

According to another embodiment, there is a computer-readable medium non-transitorily storing executable codes which, when executed on a computer receiving seismic data acquired using detectors disposed on a depth-varying profile, make the computer perform a seismic data processing method. The method further includes generating, from the seismic data, first traces (UP) that correspond to traces as recorded by the detectors and migrated to water surface, and second traces (DW) that correspond to traces as would be recorded by virtual detectors mirroring the detectors relative to the water surface and migrated to water surface. The method also includes generating (A) third traces (SYM) as a sum of corresponding ones among the first traces and second traces, and (B) fourth traces (DBG) as a difference of the corresponding ones of the first and second traces. The method then includes deghosting at least one of the first and second traces using positive and negative polarity portions of the third and fourth traces.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a marine seismic survey system with a depth-varying streamer;

FIG. 2 is a flow diagram of a method according to an exemplary embodiment;

FIG. 3 is a schematic diagram of a marine seismic survey system with a depth-varying streamer showing an example of primary signal and ghost;

FIG. 4 is a graphic illustration of a recorded trace together with a normal trace and a mirror trace generated from the recorded trace according to an exemplary embodiment;

FIG. 5 is a schematic diagram of a marine seismic survey system illustrating the concept of a virtual streamer recording down-going waves;

FIG. 6 is an image of a subsurface structure generated using normal traces;

FIG. 7 is an image of the subsurface structure generated using mirror traces;

FIG. 8 illustrates generating a SYM trace and a DBG trace;

FIG. 9 illustrates separating the SYM trace and the DBG trace in positive and negative polarity portions;

FIG. 10 illustrates deghosting the normal and the mirror trace according to an exemplary embodiment;

FIG. 11 is an image of the subsurface structure using traces deghosted as illustrated in FIG. 10;

FIG. 12 illustrates obtaining an amplified signal trace according to an exemplary embodiment;

FIG. 13 is an image of the subsurface structure using amplified signal traces obtained as illustrated in FIG. 12;

FIG. 14 is an image of the subsurface structure obtained using the joint deconvolution algorithm; and

FIG. 15 is a schematic diagram of an apparatus according to an exemplary embodiment.

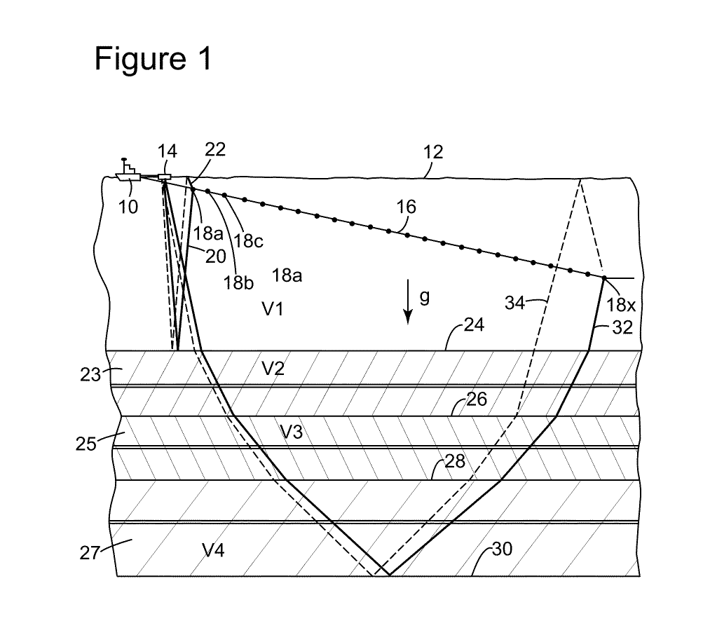

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of data processing for seismic data acquired using a streamer having a variable-depth profile.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

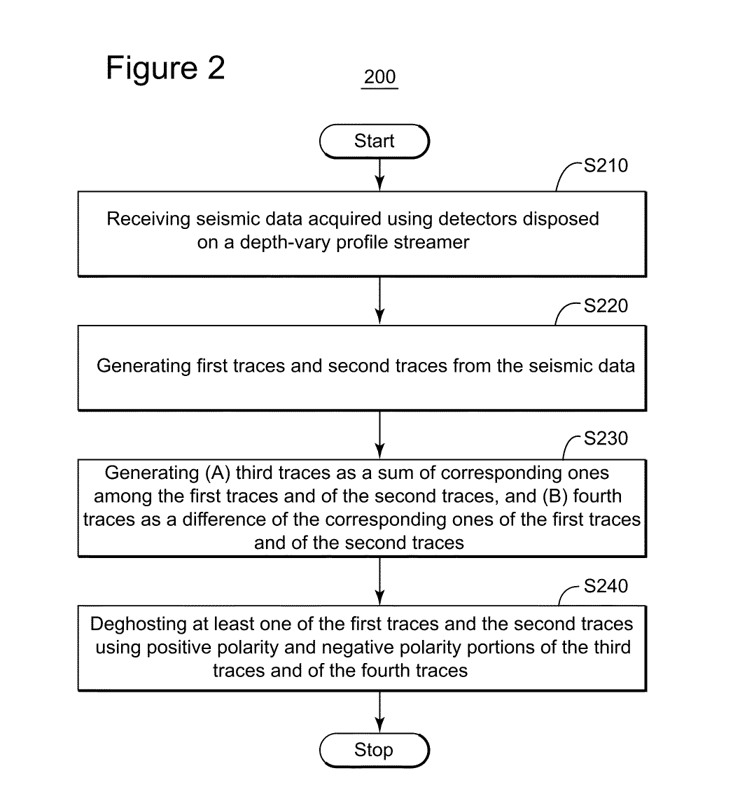

FIG. 2 illustrates a flow diagram of a method 200 for processing seismic data related to a subsurface of a body of water to generate an image of the subsurface, according to an exemplary embodiment. The method 200 includes receiving seismic data acquired with detectors disposed on a depth-varying profile streamer at S210.

The method 200 further includes generating, from the seismic data, first traces (UP) that correspond to traces as recorded by the detectors and migrated to water surface (also known as “normal traces”) and second traces (DW) that correspond to traces as would be recorded by virtual detectors mirroring the detectors relative to the water surface and migrated to water surface (also known as “mirror traces”) as explained below, at S220. The method 200 then includes generating (A) third traces (SYM) as a sum of corresponding ones among the first and second traces, and (B) fourth traces (DBG) as a difference of the corresponding ones of the first and second traces, at S230.

The method 200 also includes deghosting at least one of the first traces and second traces using positive and negative polarity portions of the third and fourth traces, at S240.

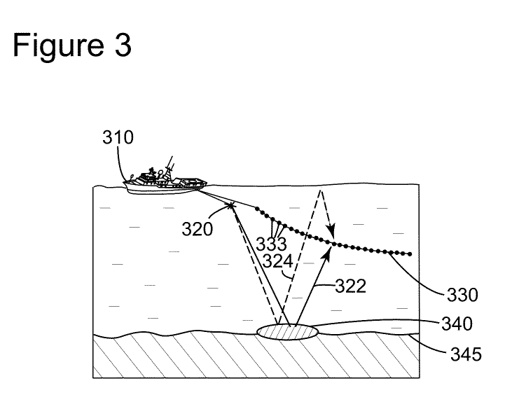

The seismic data may be acquired using a marine seismic survey system similar to the one illustrated in FIG. 3, where 310 is a vessel towing a source 320 and a variable-depth streamer 330. Detectors 333 (only some of the detectors on the streamer 330 have an indication line to the label 333) on the streamer 330 record traces that may consist of sampled reflected wave amplitudes and respective times. The primary signal 322 (illustrated using a continuous line in FIG. 3) reflected from an area 340 of the water-rock interface 345 reaches one of the detectors 333 along the streamer 330 before the ghost 324 (illustrated using a dashed line in FIG. 3). It should be understood that FIG. 3 is a proof of principle and does not accurately illustrate relative sizes and distances. For example, a distance from the water surface to the streamer 330 may be few meters (e.g., 5-60 m), while the distance from the water surface to a reflecting area 340 may be hundreds of meters (e.g., 800 m).

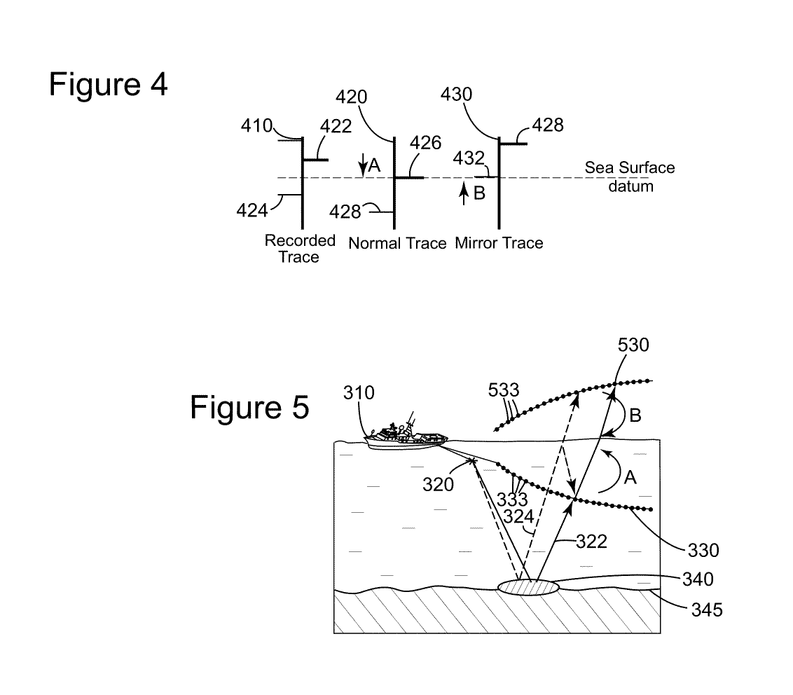

FIG. 4 is a graphic illustration a trace 410 as recorded by a detector 333, a normal trace 420 and a mirror trace 430 obtained from the recorded trace as explained below. In FIG. 4, the vertical lines represent the time flowing from up to down, the thicker horizontal lines correspond to the primary signals, the thinner horizontal lines correspond to the ghost arriving after the primary signal, and the dashed horizontal line corresponds to the water surface. As previously mentioned, the ghost has reverse polarity relative to the signal, thereby being represented on the opposite side of the time line. Thus, the recorded trace 410 includes the signal 422 and the ghost 424.

The recorded trace 410 may be migrated to the water surface (an operation known as “sea surface datum”) to obtain a normal trace 420 that includes the primary signal 426 and the ghost 428. Since the water surface has a mirror effect, one may generate a mirror trace based on the recorded trace. To understand the mirror trace, consider that instead of the water surface, there is another virtual streamer 530 as illustrated in FIG. 5. The virtual streamer 530 is symmetrical to the real streamer 330 relative to the water surface (i.e., the mirror effect). The mirror trace would be a trace as recorded by virtual detectors 533 and then migrated to the water surface similar to the normal trace (the migrations are suggested by the curved arrows A and B from the streamers 330 and 530 in FIG. 5 and corresponding arrows in FIG. 4). The mirror trace 430 includes a primary signal 428 and a ghost 432. In the view of the migrating the waves recorded by the real and virtual streamers to the water surface, the normal trace may be labeled as an up-going (UP) wave, and the mirror trace may be labeled as a down-going wave (DW).

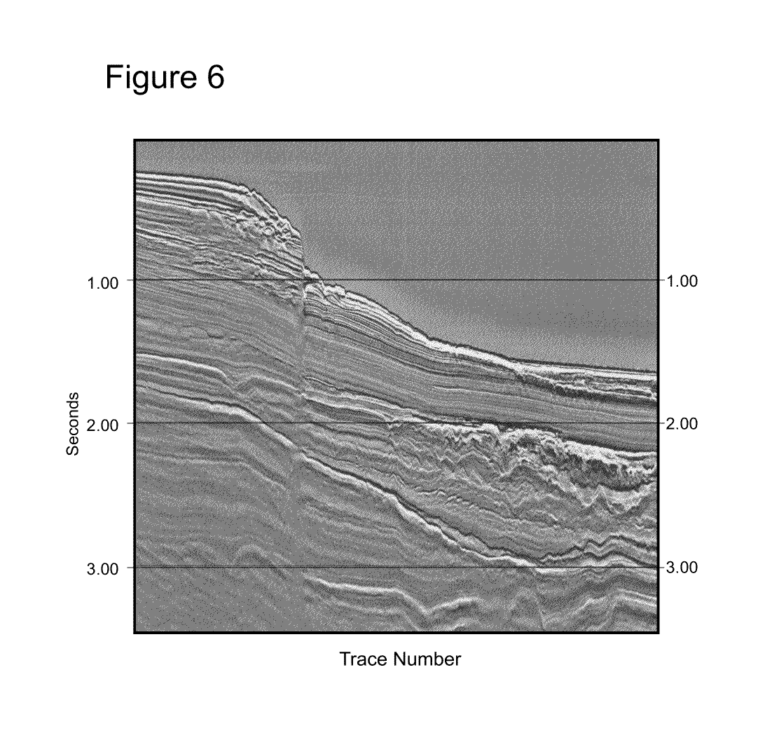

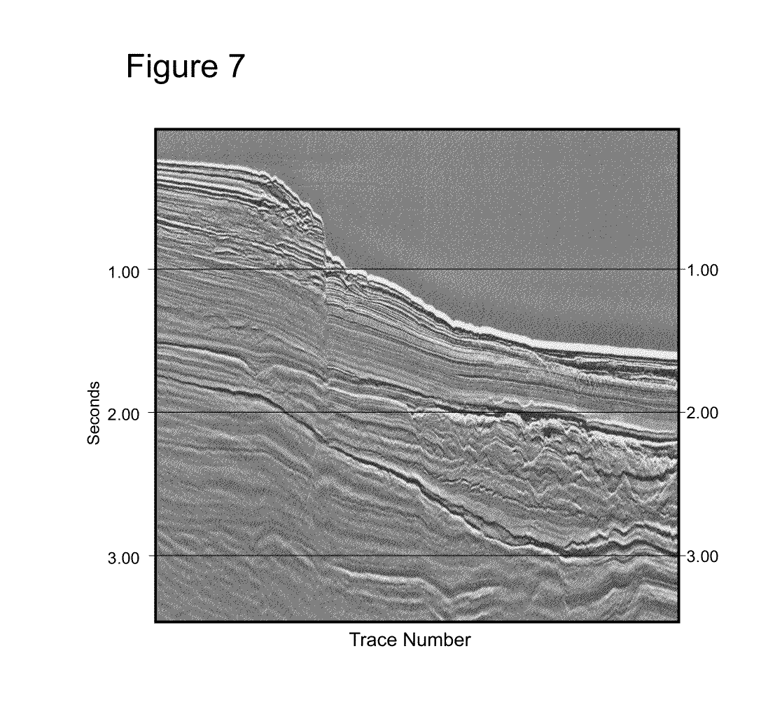

Although in the above explanations, a recorded trace corresponding to a single signal was used, in fact, each recorded trace includes plural pairs of signals and ghosts corresponding to reflections originating from different layers of the subsurface. FIG. 6 is an image of a subsurface structure generated using the normal traces, and FIG. 7 is an image of the same subsurface structure generated using the mirror traces. The presence of white hue bands in these figures is due to ghosts that are similar to shadows diluting and obscuring structural features.

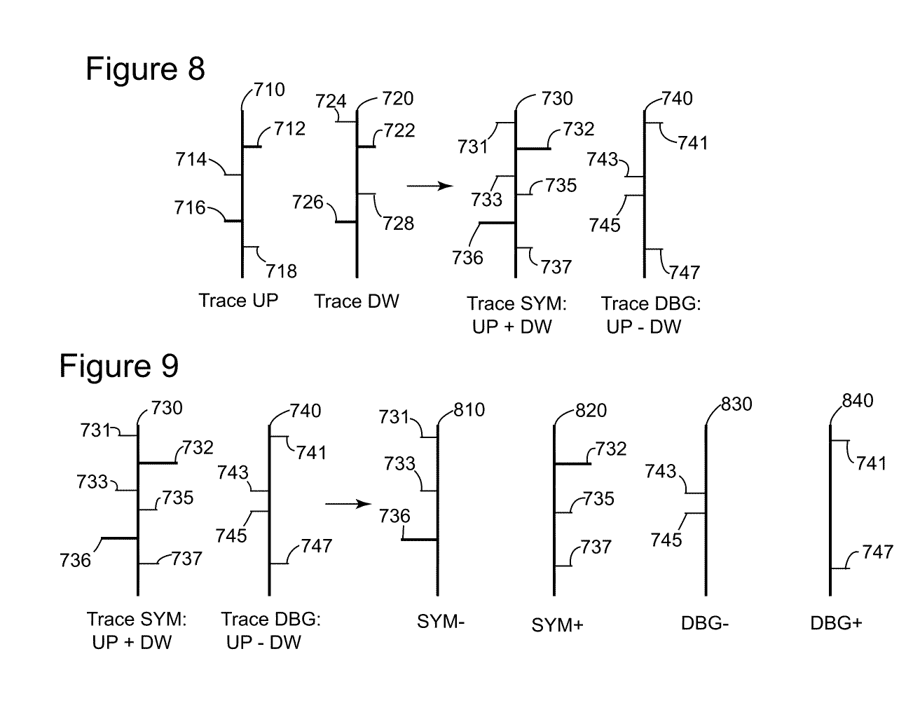

As illustrated in FIG. 8, starting from a normal trace 710 (UP) and a corresponding mirror trace 720 (DW), a “symmetrised” (SYM) trace 730 and a double ghost (DBG) trace 740 may be generated. Here, the trace 710 includes two primary signals 712 and 716 (thicker horizontal lines) and two respective ghosts 714 and 718 (thinner horizontal lines). The trace 720 also includes signals 722 and 726 and ghosts 724 and 728. The SYM trace 730 is a sum of trace 710 and trace 720, and, thus, includes strong (double amplitude) primary signals 732 and 736 and normal amplitude ghosts 731, 733, 735 and 737. The DBG trace 740 is a difference between trace 710 and trace 720, and, thus, includes ghosts 741, 743, 745 and 747.

As illustrated in FIG. 9, the SYM trace 730 and the DBG trace 740 may then be separated in a positive polarity portion and a negative polarity portion, respectively. This separation yields (A) a SYM− trace 810 including the signal 736 and the ghosts 731 and 733, (B) a SYM+ trace 820 including the signal 732 and the ghosts 735 and 737, (C) a DBG− trace 830 including ghosts 743 and 745, and (D) a DBG+ trace 840 including ghosts 741 and 747.

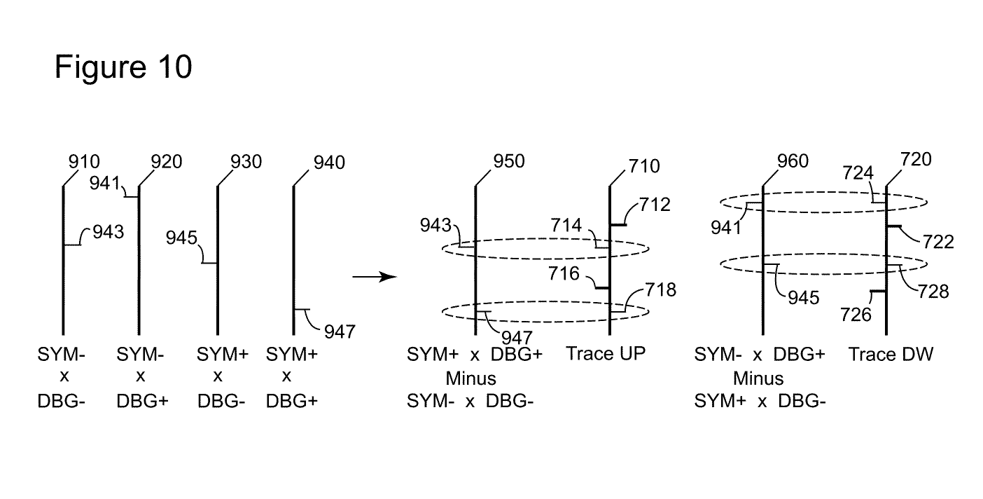

As illustrated in FIG. 10, a first trace 950 is calculated as the difference between (i) a first product 910 of the SYM− trace and the DBG− trace and (ii) a second product 940 of the SYM+ trace and the DBG+ trace (see traces SYM−, SYM+, DBG− and DBG+ in FIG. 9). As suggested by the dashed-line ovals in FIG. 10, the first difference trace 950 includes a ghost 943 and a ghost 947 corresponding to the ghosts 714 and 718 in the trace 710 (i.e., the up-going wave). Therefore, trace 710 may be deghosted by subtracting this first product trace 950 to obtain a deghosted trace including only the signals 712 and 716.

Similarly, a second trace 960 is calculated as the difference between (i) a third product 920 of the SYM− trace and the DBG+ trace and (ii) a fourth product 930 of the SYM+ trace and the DBG− trace. As suggested by the dashed-line ovals in FIG. 10, the second difference trace 960 includes a ghost 941 and a ghost 945 corresponding to the ghosts 724 and 728 in the trace 720 (i.e., the down-going wave). Therefore, the trace 720 may be deghosted by subtracting this first product trace 960.

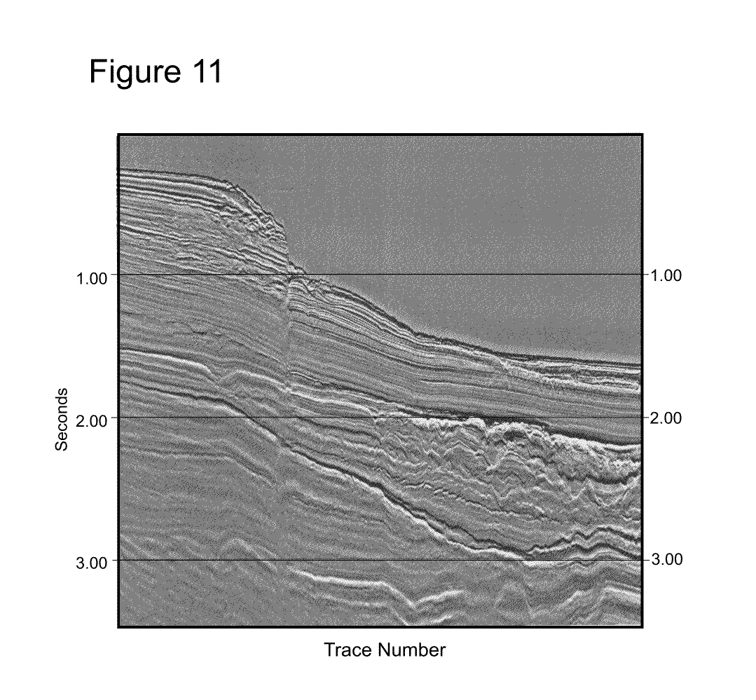

FIG. 11 an image of the subsurface structure in FIG. 6 generated using the deghosted up-going traces. It is apparent that the white shadows due to the ghosts present in FIG. 6 are diminished or removed in FIG. 11, yielding a sharper image of the subsurface structure.

The seismic data may be gathers corrected for Normal Move Out (NMO). However, the seismic data may also be time-migrated gathers or depth-migrated gathers. A velocity analysis may be performed using the deghosted traces. Migration of the deghosted traces may be performed prior to or following the velocity analysis.

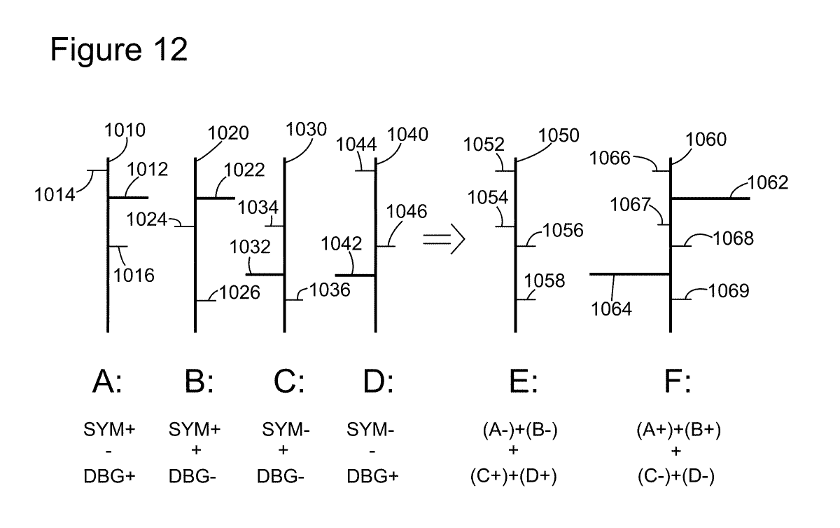

According to another embodiment, the SYM+, SYM−, DBG+ and DBG− traces (810-840 in FIG. 9) may be used to amplify the signal relative to the ghosts. As illustrated in FIG. 12, a trace A 1010 is generated as a difference of the SYM+ trace and the DBG+ trace, a trace B 1020 is generated as a sum of the SYM+ trace and the DBG− trace, a trace C 1030 is generated as a sum of the SYM− trace and the DBG− trace, and a trace D 1040 is generated as a difference of the SYM− trace and the DBG+ trace.

Trace A 1010 includes a double amplitude signal 1012 and normal amplitude ghosts 1014 and 1016. Trace B 1020 includes a double amplitude signal 1022 and normal amplitude ghosts 1024 and 1026. Trace C 1030 includes a double amplitude signal 1032 and normal amplitude ghosts 1034 and 1036. Trace D 1040 includes a double amplitude signal 1042 and normal amplitude ghosts 1044 and 1046.

An amplified signal trace 1060 may be calculated by adding positive polarity portions of the traces A and B with the negative polarity portions of the traces C and D. The amplified signal trace 1060 includes four time amplitude signals 1062 and 1064 and normal amplitude ghosts 1066, 1067, 1068, and 1069.

A “ghost only” trace 1050 E may be calculated by adding the negative polarity portions of the traces A and B with the positive polarity portions of the traces C and D. The ghost only trace 1050 includes normal amplitude ghosts 1052, 1054, 1056 and 1058.

The amplified signal trace 1060 may be deghosted by subtracting the ghost-only trace 1050. Alternatively, the method may be reiterated by considering one of the E and F traces being the up-going (normal) trace and the other one of the E and F traces being the down-going (mirror) trace. Each iteration causes improvement of the signal to ghost ratio: the first iteration achieves an increase of the amplitude of the signals relative to the ghosts of 4; the second iteration achieves an increase of the amplitude of the signals relative to the ghosts of 8; the n^{th} iteration achieves an increase of the amplitude of the signals relative to the ghosts of 2⁽ⁿ⁺¹⁾. Thus, after a iteration, the ghost are not removed completely but the signal to ghost ratio is significantly improved.

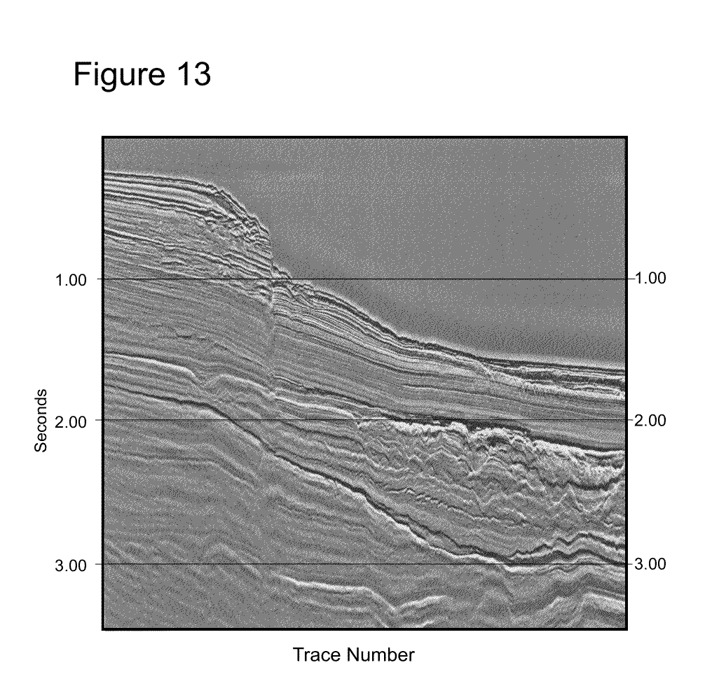

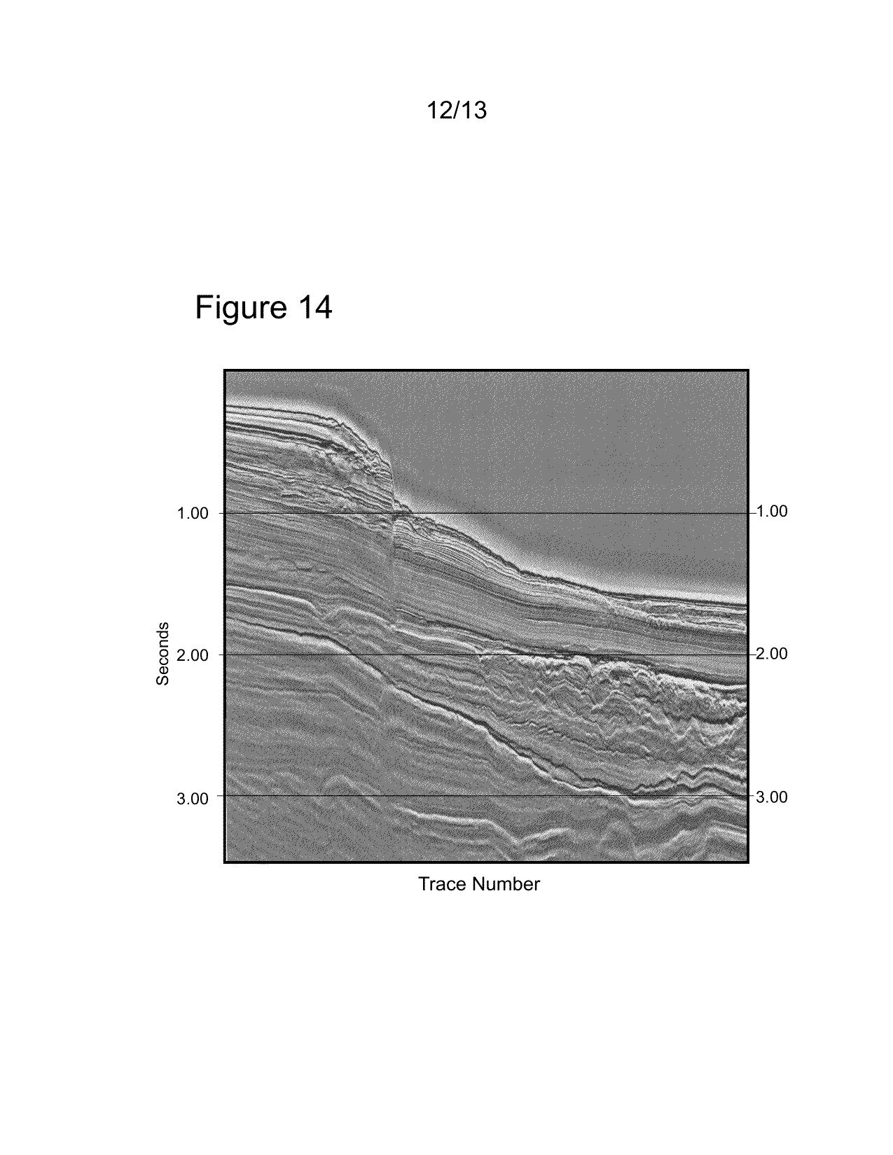

FIG. 13 is an image of the same subsurface structure as illustrated in FIGS. 6, 7 and 11, the image being obtained using the amplified signal traces. FIG. 14 is an image of the sub surface structure using the traditional joint deconvolution algorithm.

In contrast to conventional methods using the joint decomposition algorithm, the above-described embodiment methods have the advantage that they perform a trace-by-trace processing, leading to a very fast execution time. Additionally, these embodiments do not require accurate knowledge of the velocity field or a mute library. The novel methods discussed above could be applied either on NMO-corrected gathers, or on time/depth migrated gathers.

These quick trace deghosting methods can be used for intermediate processing stages: velocity analysis before migration, velocity analysis during migration—perturbed velocity stacks, velocity analysis after time/depth migration—automatic RMO picking and/or intermediate QC gathers or stacks before/after migrations.

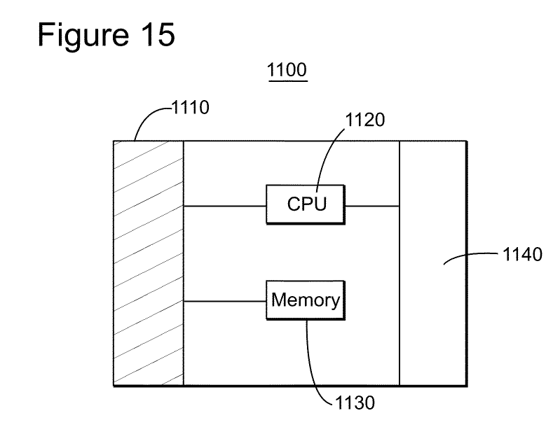

A schematic diagram of an apparatus 1100 for processing seismic data related to a subsurface of a body of water to generate an image of the subsurface is illustrated in FIG. 15. The apparatus 1100 includes an interface 1110 configured to receive seismic data acquired with detectors disposed on a depth-varying profile.

The apparatus 1100 further includes a data processing unit 1120 connected to the interface 1110. The apparatus 1100 may also include a memory 1130. The memory 1130 may be configured to store the seismic data and/or to non-transitorily store executable codes which, when executed by the data processing unit 1120, make the data processing unit execute, for example, steps S220-S240 of the method 200.

The apparatus 1100 may also include a display 1140 connected to the data processing unit 1120 and configured to display an image corresponding to the deghosted first and second traces.

The data processing unit 1120 is configured (i) to extract first traces (UP) related to up-going waves, and second traces (DW) related to down-going waves from the seismic data; (ii) to generate third traces (SYM) as a sum of corresponding ones among the first and second traces, and fourth traces (DBG) as a difference of the corresponding one of the first traces and the second traces; and (iii) to deghost at least one of the first and second traces using positive and negative polarity portions of the third and fourth traces.

In one embodiment, the data processing unit 1120 may be configured to deghost the first and second traces by (i) separating (A) the third traces into fifth traces (SYM+) representing a positive polarity portion of the third traces, and sixth traces (SYM−) representing a negative polarity portion of the third traces, and (B) the fourth traces into seventh traces (DBG+) representing a positive polarity portion of the fourth traces, and eighth traces (DBG−) representing a negative polarity portion of the fourth traces; (ii) calculating deghosted first traces by subtracting a difference between a first product (SYM+×DBG+) of the fifth traces and the seventh, and a second product (SYM−×DBG−) between the sixth traces and the eighth traces; and (iii) calculating deghosted second traces by subtracting a difference between a third product (SYM−×DBG+) of the sixth traces and the seventh, and a fourth product (SYM+×DBG−) between the fifth traces and the eighth traces.

The apparatus 1100 may be configured to process seismic data that are gathers corrected for normal moveout (NMO), and/or time migrated gathers and/or depth migrated gathers.

In yet another embodiment, the data processing unit 1120 may be configured to deghost the first traces and the second traces by
separating (A) the third traces into fifth traces (SYM+) representing a positive polarity portion of the third traces and sixth traces (SYM−) representing a negative polarity portion of the third traces, and (B) the fourth traces into seventh traces (DBG+) representing a positive polarity portion of the fourth traces and eighth traces (DBG−) representing a negative polarity portion of the fourth traces;
calculating (i) ninth traces (SYM+−DBG+) as a difference of fifth traces and seventh traces, (ii) tenth traces (SYM++DBG−) as a sum of the fifth traces and eighth traces, (iii) eleventh traces (SYM−+DBG+) as a sum of the sixth traces and seventh traces, and (iv) twelfth traces (SYM−−DBG+) as a difference of the sixth traces and the eighth traces;
calculating amplified signal traces by adding the positive polarity part of the ninth trace, positive polarity part of the tenth trace, negative polarity part of the eleventh trace and negative polarity part of the twelfth trace; and
calculating ghost traces by adding the positive polarity part of the ninth trace, positive polarity part of the tenth trace, negative polarity part of the eleventh trace and negative polarity part of the twelfth trace.

The disclosed exemplary embodiments provide a system and a method for fast-deghosting traces. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for processing seismic data related to a structure under a body of water to generate an image of the structure, the method comprising:
receiving seismic data acquired with detectors disposed on a depth-varying profile streamer;
generating, from the seismic data,
first traces (UP) that correspond to traces as recorded by the detectors and migrated to water surface, and
second traces (DW) that correspond to traces as would be recorded by virtual detectors mirroring the detectors relative to the water surface and migrated to water surface;
generating (A) third traces (SYM) as a sum of corresponding ones among the first traces and the second traces, and (B) fourth traces (DBG) as a difference of the corresponding ones among the first traces and the second traces; and
deghosting at least one of the first traces and the second traces using positive and negative polarity portions of the third traces and of the fourth traces.

2. The method of claim 1, wherein the deghosting comprises:
separating (i) the third traces into fifth traces (SYM+) representing a positive polarity portion of the third traces and sixth traces (SYM−) representing a negative polarity portion of the third traces, and (ii) the fourth traces into seventh traces (DBG+) representing a positive polarity portion of the fourth traces and eighth traces (DBG−) representing a negative polarity portion of the fourth traces;
calculating deghosted first traces as a difference between a first product (SYM+×DBG+) of the fifth traces and the seventh and a second product (SYM−×DBG−) between the sixth traces and the eighth traces; and
calculating deghosted second traces as a difference between a third product (SYM−×DBG+) of the sixth traces and the seventh and a fourth product (SYM+×DBG−) between the fifth traces and the eighth traces.

3. The method of claim 1, wherein a trace includes one or more pairs of a signal and a ghost that correspond to waves reflected from substantially same depth.

4. The method of claim 1, wherein the seismic data are gathers corrected for normal moveout (NMO).

5. The method of claim 1, wherein the seismic data are time migrated gathers or depth migrated gathers.

6. The method of claim 1, further comprising:
performing a velocity analysis using the deghosted first traces and/or the deghosted second traces.

7. The method of claim 6, further comprising:
performing migration of the deghosted first traces and/or the deghosted second traces prior to performing the velocity analysis.

8. The method of claim 6, further comprising:
performing migration of the deghosted first traces and/or the deghosted second traces after the velocity analysis.

9. The method of claim 1, wherein the deghosting comprises:
separating (A) the third traces into fifth traces (SYM+) representing a positive polarity portion of the third traces and sixth traces (SYM−) representing a negative polarity portion of the third traces, and (B) the fourth traces into seventh traces (DBG+) representing a positive polarity portion of the fourth traces and eighth traces (DBG−) representing a negative polarity portion of the fourth traces;
calculating (i) ninth traces (SYM+−DBG+) as a difference of fifth traces and seventh traces, (ii) tenth traces (SYM++DBG−) as a sum of the fifth traces and eighth traces, (iii) eleventh traces (SYM−+DBG+) as a sum of the sixth traces and seventh traces, and (iv) twelfth traces (SYM−−DBG+) as a difference of the sixth traces and the eighth traces; and
calculating amplified signal traces by adding positive polarity part of the ninth trace, positive polarity part of the tenth trace, negative polarity part of the eleventh trace and negative polarity part of the twelfth trace.

10. The method of claim 9, further comprising:
calculating ghost traces by adding positive polarity part of the ninth trace, positive polarity part of the tenth trace, negative polarity part of the eleventh trace and negative polarity part of the twelfth trace; and
deghosting the amplified signal traces by subtracting corresponding one of the ghost traces.

11. The method of claim 9, further comprising:
calculating ghost traces by adding positive polarity part of the ninth trace, positive polarity part of the tenth trace, negative polarity part of the eleventh trace and negative polarity part of the twelfth trace;
making one of the first traces or the second traces equal to one of the amplified signal traces and the ghost traces, and another one of the first traces and the second traces equal to the other one of the amplified signal and the ghost traces; and
recalculating the third traces (SYM) as a sum of corresponding ones among the first traces and the second traces, and the fourth traces (DBG) as a difference of the corresponding ones among the first traces and the second traces.

12. An apparatus for processing seismic data related to a subsurface of a body of water to generate an image of the subsurface, that apparatus comprising:
an interface configured to receive seismic data acquired using detectors disposed on a depth-varying profile; and
a data processing unit connected to the interface and configured
(i) to generate, from the seismic data,
first traces (UP) that correspond to traces as recorded by the detectors and migrated to water surface, and
second traces (DW) that correspond to traces as would be recorded by virtual detectors mirroring the detectors relative to the water surface and migrated to water surface,
(ii) to generate (A) third traces (SYM) as a sum of corresponding ones among the first traces and the second traces, and (B) fourth traces (DBG) as a difference of the corresponding ones among the first traces and the second traces, and
(iii) to deghost at least one of the first traces and the second traces using positive and negative polarity portions of the third traces and of the fourth traces.

13. The apparatus of claim 12, wherein the data processing unit is configured to deghost the first traces and the second traces by
separating (A) the third traces into fifth traces (SYM+) representing a positive polarity portion of the third traces and sixth traces (SYM−) representing a negative polarity portion of the third traces, and (B) the fourth traces into seventh traces (DBG+) representing a positive polarity portion of the fourth traces and eighth traces (DBG−) representing a negative polarity portion of the fourth traces; and
calculating deghosted first traces by subtracting a difference between a first product (SYM+×DBG+) of the fifth traces and the seventh and a second product (SYM−×DBG−) between the sixth traces and the eighth traces; and
calculating deghosted second traces by subtracting a difference between a third product (SYM−×DBG+) of the sixth traces and the seventh and a fourth product (SYM+×DBG−) between the fifth traces and the eighth traces.

14. The apparatus of claim 12, wherein a trace includes one or more pairs of a signal and a ghost that correspond to waves reflected from substantially same depth.

15. The apparatus of claim 12, wherein the seismic data are gathers corrected for normal moveout (NMO).

16. The apparatus of claim 12, wherein the seismic data are time migrated gathers or depth migrated gathers.

17. The apparatus of claim 12, further comprising:
a display connected to the data processing unit and configured to display an image corresponding to the deghosted first traces and the deghosted second traces.

18. The apparatus of claim 12, wherein the data processing unit is configured to deghost the first traces and the second traces by
separating (A) the third traces into fifth traces (SYM+) representing a positive polarity portion of the third traces and sixth traces (SYM−) representing a negative polarity portion of the third traces, and (B) the fourth traces into seventh traces (DBG+) representing a positive polarity portion of the fourth traces and eighth traces (DBG−) representing a negative polarity portion of the fourth traces;
calculating (i) ninth traces (SYM+−DBG+) as a difference of fifth traces and seventh traces, (ii) tenth traces (SYM++DBG−) as a sum of the fifth traces and eighth traces, (iii) eleventh traces (SYM−+DBG+) as a sum of the sixth traces and seventh traces, and (iv) twelfth traces (SYM−−DBG+) as a difference of the sixth traces and the eighth traces;
calculating amplified signal traces by adding positive polarity part of the ninth trace, positive polarity part of the tenth trace, negative polarity part of the eleventh trace and negative polarity part of the twelfth trace;
calculating ghost traces by adding positive polarity part of the ninth trace, positive polarity part of the tenth trace, negative polarity part of the eleventh trace and negative polarity part of the twelfth trace; and
deghosting the amplified signal traces by subtracting corresponding one of the ghost traces.

19. The apparatus of claim 12, wherein the data processing unit is configured to make one of the first traces or the second traces equal to one of the amplified signal traces and the ghost traces, and another one of the first traces and the second traces equal to the other one of the amplified signal and the ghost traces; and
to recalculate the third traces (SYM) as a sum of corresponding ones among the first traces and the second traces, and the fourth traces (DBG) as a difference of the corresponding ones among the first traces and the second traces.

20. A computer readable medium non-transitorily storing executable codes which when executed on a computer receiving seismic data acquired using detectors disposed on a depth-varying profile make the computer perform a seismic data processing method comprising:
generating, from the seismic data,
first traces (UP) that correspond to traces as recorded by the detectors and migrated to water surface, and
second traces (DW) that correspond to traces as would be recorded by virtual detectors mirroring the detectors relative to the water surface and migrated to water surface;
generating (A) third traces (SYM) as a sum of corresponding ones among the first traces and the second traces, and (B) fourth traces (DBG) as a difference of the corresponding ones among the first traces and the second traces; and
deghosting at least one of the first traces and the second traces using positive and negative polarity portions of the third traces and of the fourth traces.
